(19) United States
(12) Patent Application Publication
(10) Pub. No.: US 2007/0187051 A1
(43) Pub. Date: Aug. 16, 2007

(54) Method for forming a slat piece for venetian blind and the slat piece thus formed

(75) Inventor: Mao-Sung Chen, Taoyuan County (TW)

Correspondence Address: BACON & THOMAS, PLLC, 625 SLATERS LANE, FOURTH FLOOR, ALEXANDRIA, VA, 22314, US

(73) Assignee: C.M.C. Curtain Fabric Co., Ltd., Taoyuan County (TW)

(21) Appl. No.: 11/350,800

(22) Filed: Feb. 10, 2006

(51) Int. Cl. E06B 3/12

(52) U.S. Cl. 160/236

(57) ABSTRACT

A slat piece for Venetian blinds is provided. The slat piece includes a substrate having a front surface having a first longitudinal edge, a second opposite longitudinal edge, and a first, a second and a third adhesive areas and a back surface. The first adhesive area extends along a portion of the front surface that is adjacent to the first longitudinal edge, the third adhesive area extends along a portion of the front surface that is adjacent to the second longitudinal edge, and the second adhesive area extends between the first and third adhesive areas on the front surface and divides the front surface into a first and a second empty areas that do not include adhesive.

### BACKGROUND OF THE INVENTION

The present invention generally related to a slat piece for a Venetian blind. More specifically, the present invention relates to a method of forming a slat piece for Venetian blinds.

Blinds for covering windows and other light transparent surfaces are available in a variety of different forms and materials depending on the particular visual appearance desired. U.S. Pat. No. 6,105,657 discloses a fabric blind slat 10 for Venetian blinds as shown in FIG. 1. The fabric blind slat 10 is made of a flexible woven piece 11 having a tubular engaging passage 12 disposed at both longitudinal sides thereon respectively for a stiff supporting rod 16 to be joined therein to expand the blind slat 10 horizontally.

There are some drawbacks to such conventional slat structure for a Venetian blind. First, the fabric blind slat 10 is formed by the weaving operation before the supporting rods 16 are sequentially mounted and located into the tubular engaging passages 12 disposed at both longitudinal sides of the blind slat 10 thereof, which is both complicated and time-consuming in assembly as well as production. Second, the slat 10 itself is formed of a textile material, the need arises not only to stiffen the fabric sufficiently for it to retain a substantially planar form, but also to bond the fibers of the warps to an extent sufficient to prevent fraying out at the longitudinal edges of the slat, and to prevent unraveling of the threads. Third, slats made from textile material generally suffer a lower impermeability to light.

### SUMMARY OF THE INVENTION

The present invention provides a method for forming a slat piece for Venetian blinds and a slat piece thus formed. The slat piece includes a substrate having a front and a back surface. The front surface includes a first longitudinal edge, a second opposite longitudinal edge, and three areas of adhesive. Each of the adhesive areas extends in a longitudinal direction of the slat piece.

In an embodiment of the present invention, the first, second, and third adhesive areas define two empty areas that do not include adhesive on the front surface for forming tubular engaging passage(s).

In another embodiment of the present invention, a method for forming a slat piece is provided. The method comprises the steps of: providing a substrate including a front surface having a first longitudinal edge, a second opposite longitudinal edge, a first, a second and a third elongated adhesive areas sequentially extending on the front surface from the first longitudinal edge to the second longitudinal edge and forming a first and a second empty areas that do not include adhesive; folding the first longitudinal edge of the front surface toward the second longitudinal edge of the front surface along a central axis of the first empty area so that the first adhesive area overlaps the second adhesive area and forms a first elongated passage with the first empty area; and folding the second longitudinal edge of the front surface toward the first longitudinal edge of the front surface along a central axis of the second empty area so that the third adhesive area contacts the first longitudinal edge folded upward and forms a second elongated passage with the second empty area.

### BRIEF DESCRIPTION OF THE DRAWINGS

FIG. 1 illustrates a perspective view of a conventional slat structure for Venetian blind;

FIG. 2 illustrates a perspective view of a slat piece according to a first embodiment of the present invention;

FIG. 3 illustrates a perspective view of a substrate for forming the slat piece in FIG. 2;

FIG. 4 illustrates a perspective view of a substrate in FIG. 3 in a step of forming the slat piece in FIG. 2;

FIG. 5 illustrates a perspective view of a slat piece according to a second embodiment of the present invention;

FIG. 6 illustrates a perspective view of a substrate in FIG. 3 in a step of forming the slat piece of FIG. 5; and

FIG. 7 illustrates a schematic view of a method and apparatus for manufacturing the slat piece of the present invention.

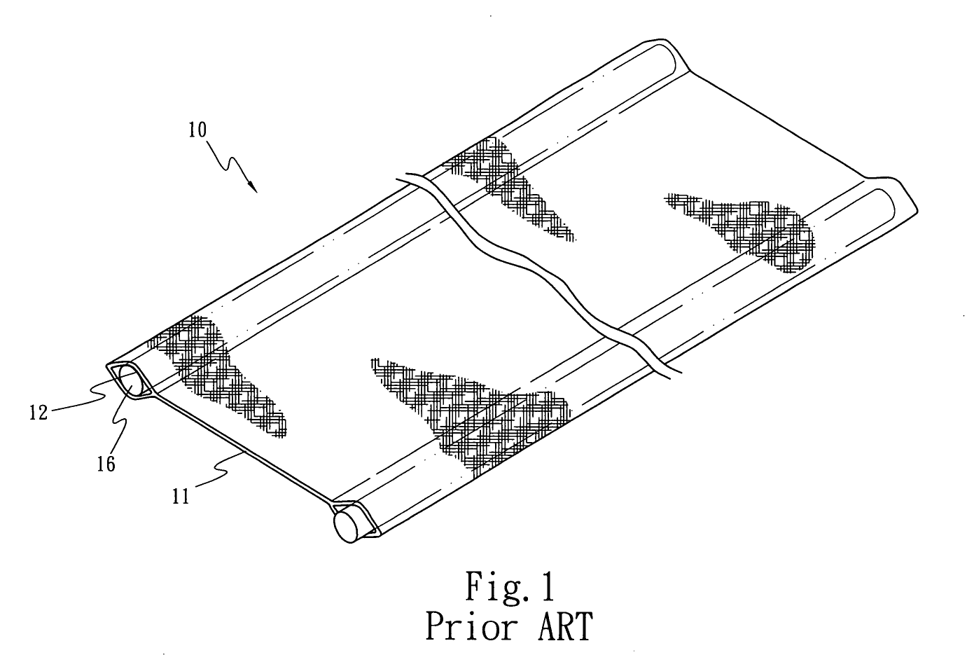

### DETAILED DESCRIPTION OF THE PREFERRED EMBODIMENTS

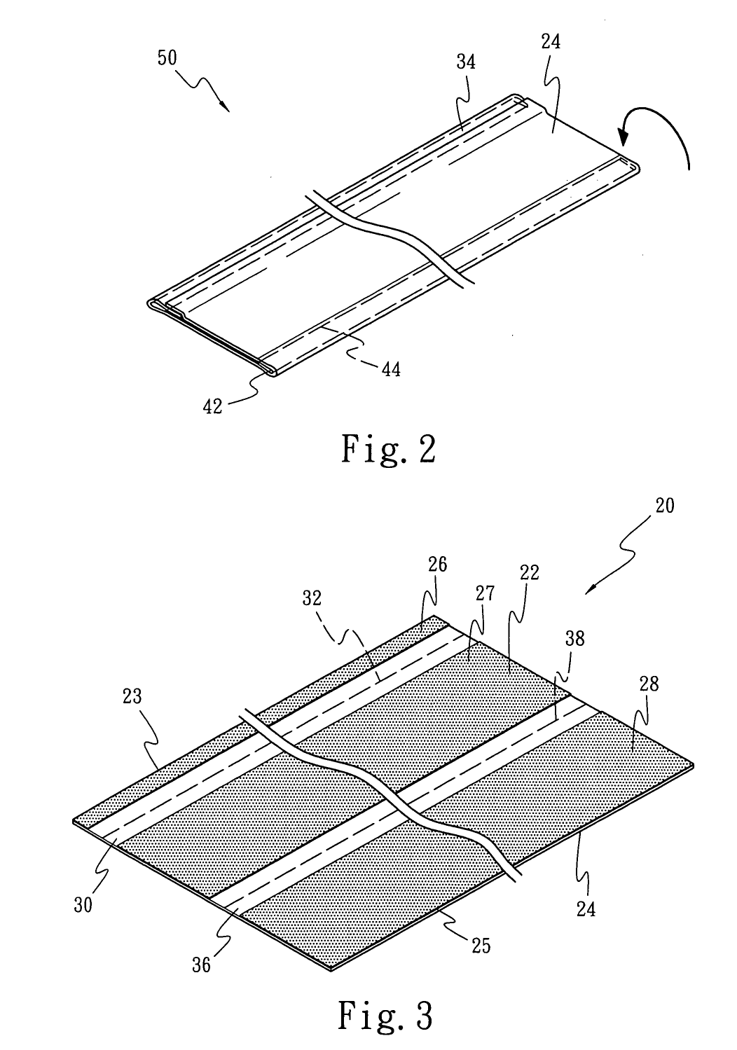

The present invention provides an improved method for forming a slat piece 50 in FIG. 2 for Venetian blinds and slat pieces thus formed. The slat piece 50 according to the present invention facilitates an easy and fast assembly of the slat structure to achieve economical efficiency and competitive power thereof.

In an embodiment, a substrate 20 for forming a slat piece according to the present invention is shown in FIG. 3. The substrate 20 is prepared by thermally forming a slat base from a felt batt, and optionally securing a layer of fabric to the slat base. The fabric may be natural (e.g. silk, cotton, wool, linen and the like), or synthetic, and the fabric may be treated with known fire retardants, stain or water repellants, dust repellants, UV light stabilizers, etc. In one embodiment, the substrate is a blind fabric utilizing natural or synthetic fibers of fabric as base materials to form an inexpensive fabric used in conjunction with conventional Venetian blinds and formed by a method comprising dipping, compressing, tentering, slitting into desired widths, heating, and forming as disclosed by U.S. Pat. No. 5,273,781.

The substrate 20 includes a front surface 22 and a back surface 24. The front surface 22 includes a first longitudinal edge 23, a second longitudinal edge 25 opposite to the first longitudinal edge, a first, a second, and a third elongated adhesive areas 26, 27, and 28 sequentially positioned on the front surface 22 from the first longitudinal edge 23 to the second longitudinal edge 24 and forming a first and a second empty areas 30, 36 that do not include adhesive. Each of the empty areas 30 and 36 has a respective central axis 32, 38 extending in a longitudinal direction of the substrate 20.

The application of adhesive onto the front surface 22 may be implemented in any conventional manner, such as by means of roller and doctor blade arrangement as is well known in the art. Preferably, the adhesive may be a heat activated adhesive, such as Polyurethane Reactive (PUR) hot melt adhesive.

In the embodiment of the substrate 20 illustrated in FIG. 3, the three adhesive areas 26, 27, and 28 are oriented along, or in juxtaposition to the longitudinal edges. In the preferred embodiment illustrated, the first adhesive area 26 is applied with adhesive. It should be noted, however, that the adhesive area 26 do not need to apply the adhesive and the width of the adhesive area 26 is chosen so as to insure that the first longitudinal edge can be fixed onto the second adhesive area 27.

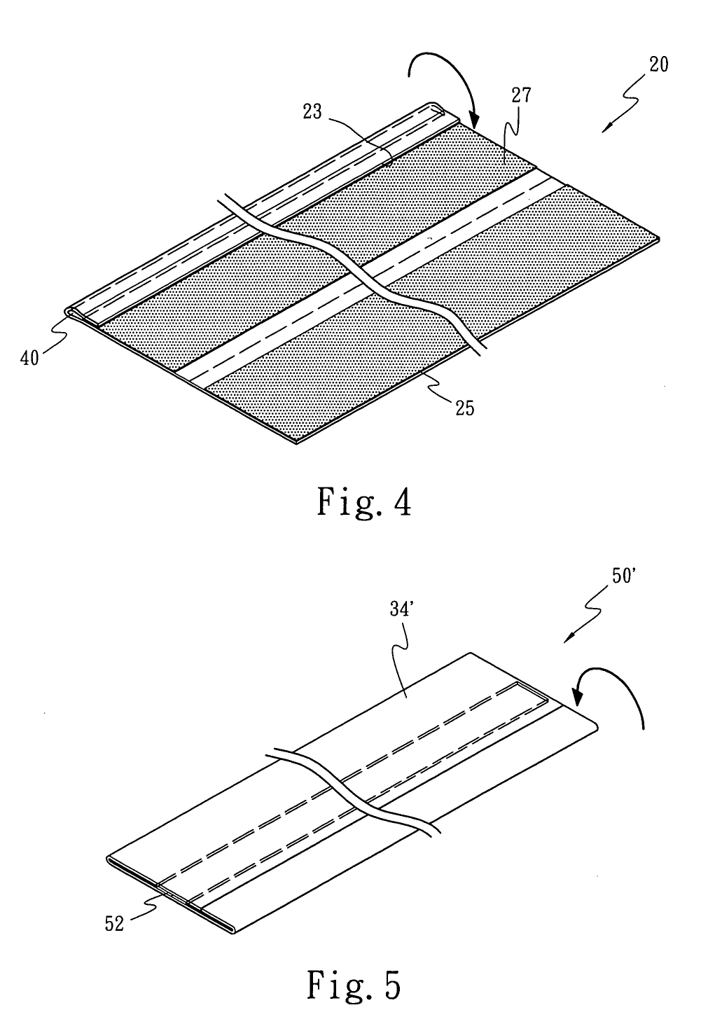

FIGS. 4 and 2 illustrates the method for forming the slat piece 50 in according with a first embodiment of this invention. As shown in FIG. 4, the substrate 20 is folded so by folding the first longitudinal edge 23 of the front surface toward the second longitudinal edge 25 of the front surface along the central axis 32 (in FIG. 3) of the first empty area 30 (in FIG. 3) so that the first adhesive area overlaps the second adhesive area 27 and forms a first elongated passage 40 with the folded first empty area 30 (in FIG. 3).

In the preferred embodiment illustrated, the first longitudinal edge 23 folds over a minor extent of the width of the second adhesive area 27, for example 2 millimeters. However, of course, the first longitudinal edge 23 can fold over a greater or less extent of the width of the second adhesive area 27 as long as the first longitudinal edge 26 is fixedly secured onto the second adhesive area 27.

In the next step of the process, illustrated in FIG. 2, the second longitudinal edge is folded over along the central axis 38 of the second empty area 36 so that the third adhesive area 28 contacts a portion 34 of the back surface 24 of the substrate 20. This forms a second elongated passage 42 (depicted by a phantom line 44) and completes the slat piece 50 according to the first embodiment of the present invention.

FIG. 5 shows a slat piece 50′ in accordance with the second embodiment of the present invention, wherein only one elongated passage 52 (depicted by phantom lines) is formed in the slat piece 50′. In this embodiment, the slat piece 50′ is formed by using the substrate 20 shown in FIG. 3.

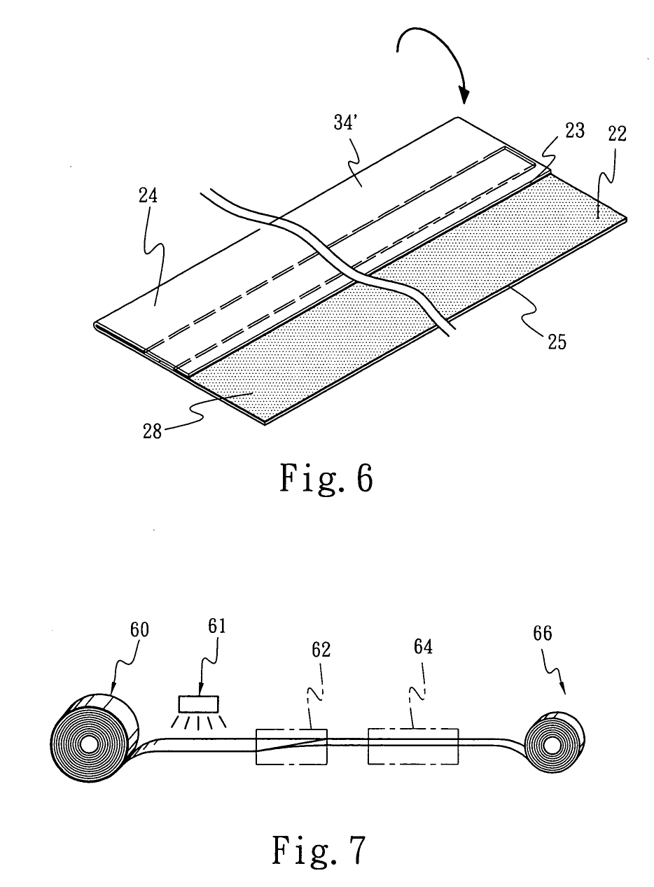

As illustrated in FIG. 6, the first longitudinal edge 23 of the front surface 22 is folded toward the second longitudinal edge 25 of the front surface 22 so as to cause the first empty area 30 and second empty area 36 (shown in FIG. 3) coincide with each other. This causes the first longitudinal edge 23 of the front surface to contact the third adhesive area 28 and forms a portion 34′ of back surface 24 as shown.

In the next step of process, illustrated in FIG. 5, the second longitudinal edge 25 is folded over so that the third adhesive area 28 contacts the portion 34′ of the back surface 24 and the passage 52 is thus formed.

FIG. 7 illustrates schematically a manufacturing process in a production line. A roll of slat base 60 is fed to a gluing stage 61 where the adhesive is applied at predetermined spaced location as to form the substrate 20 shown in FIG. 3. A folding stage 62 is then used to fold the glued substrate 20 by using a suitable means, such as a standard plow folder or gate folder. After the folding stage 62, the folded substrate 20 is then fed to a processing machine 64 which applies pressure and heat to the moving substrate after which the substrate becomes adhesively bonded thus precluding movement of the pleats out of their assembly position. After cooling, the completed slat piece is reeled up and collected on a take-up roller 66. Alternatively, the completed slat piece may be transversely chopped into individual slat pieces with a cutter (not shown).

While preferred embodiments of the present invention are shown and described, it is envisioned that those skilled in the art may devise various modifications of the present invention without departing from the spirit and scope of the appended claims.

The invention claimed is:

1. A slat piece for Venetian blinds, comprising:
a substrate that folds to form the slat piece, the substrate prior to folding having a front surface having a first longitudinal edge, a second opposite longitudinal edge, and a first, a second and a third adhesive areas with the first adhesive area extending along a portion of the front surface that is adjacent to the first longitudinal edge, the third adhesive area extending along a portion of the front surface that is adjacent to the second longitudinal edge, and the second adhesive area extending between the first and third adhesive areas on the front surface and divides the front surface into a first and a second empty areas that do not include adhesive; and
the slat piece being formed when the first longitudinal edge of the front surface is folded toward the second longitudinal edge of the front surface along a central axis of the first empty area so that the first adhesive area overlaps the second adhesive area and forms a first elongated passage with the first empty area and the second longitudinal edge of the front surface toward the first longitudinal edge of the front surface along an axis of the second empty area so that the third adhesive area contacts the first longitudinal edge folded upward and forms a second elongated passage with the second empty area.

2. The slat piece of claim 1, wherein the first adhesive area is not applied with adhesive.

3. The slat piece of claim 1, wherein the adhesive is a heat activated adhesive.

4. The slat piece of claim 3, wherein the heat activated adhesive is Polyurethane Reactive (PUR) hot melt adhesive.

5. The slat piece of claim 1, wherein the first adhesive area has a width of 2 millimeters or greater.

6. A method for forming a slat piece for Venetian blinds, comprising:
a providing step for providing a substrate including a front surface having a first longitudinal edge, a second opposite longitudinal edge, a first, a second and a third elongated adhesive areas sequentially applied on the front surface from the first longitudinal edge to the second longitudinal edge and forming a first and a second empty areas that do not include adhesive;
a first folding step for folding the first longitudinal edge of the front surface toward the second longitudinal edge of the front surface along a central axis of the first empty area so that the first adhesive area overlaps the second adhesive area and forms a first elongated passage with the first empty area; and
a second folding step for folding the second longitudinal edge of the front surface toward the first longitudinal edge of the front surface along an axis of the second empty area so that the third adhesive area contacts the first longitudinal edge folded upward and forms a second elongated passage with the second empty area.

7. The method of claim 6, further comprising a step of applying pressure and heat to the slat piece after the second folding step.

8. The method of claim 7, wherein the first adhesive area has a width of 2 millimeters or greater.

9. A slat piece for Venetian blinds, comprising:
a substrate that folds to form the slat piece, the substrate prior to folding having a front surface having a first longitudinal edge, a second opposite longitudinal edge, and a first, a second and a third adhesive areas and a back surface with the first adhesive area extending along a portion of the front surface that is adjacent to the first longitudinal edge, the third adhesive area extending along a portion of the front surface that is adjacent to the second longitudinal edge, and the second adhesive area extending between the first and third adhesive areas on the front surface and divides the front surface into a first and a second empty areas that do not include adhesive; and
the slat piece being formed when the first longitudinal edge of the front surface is folded toward the second longitudinal edge of the front surface so as to cause the first empty area and second empty area coincide with each other and the first longitudinal edge of the front surface to contact the third adhesive area and the second longitudinal edge is folded over so that the third adhesive area contacts the back surface and form a passage.

10. The slat piece of claim 9, wherein the first adhesive area is not applied with adhesive.

11. The slat piece of claim 9, wherein the adhesive is a heat activated adhesive.

12. The slat piece of claim 11, wherein the heat activated adhesive is Polyurethane Reactive (PUR) hot melt adhesive.

13. The slat piece of claim 9, wherein the first adhesive area has a width of 2 millimeters or greater.

14. A method for forming a slat piece for Venetian blinds, comprising:
a providing step for providing a substrate including a front surface having a first longitudinal edge, a second opposite longitudinal edge, a first, a second and a third elongated adhesive areas sequentially applied on the front surface from the first longitudinal edge to the second longitudinal edge and forming a first and a second empty areas that do not include adhesive and a back surface;
a first folding step for folding the first longitudinal edge of the front surface toward the second longitudinal edge of the front surface so as to cause the first empty area and second empty area coincide with each other and the first longitudinal edge of the front surface to contact the third adhesive area; and
a second folding step of folding the second longitudinal edge over so that the third adhesive area contacts the back surface.

15. The method of claim 14, further comprising a step of applying pressure and heat to the slat piece after the second folding step.

16. The method of claim 14, wherein the first adhesive area has a width of 2 millimeters or greater.
